(19) United States
(12) Patent Application Publication
(10) Pub. No.: US 2024/0102191 A1
(43) Pub. Date: Mar. 28, 2024

(54) PROCESS FOR OPERATING AN ELECTROLYSIS APPARATUS AND ELECTROLYSIS APPARATUS

(71) Applicant: Siemens Energy Global GmbH & Co. KG, München (DE)

(72) Inventors: Alexander Tremel, Möhrendorf (DE); Erik Wolf, Röttenbach (DE)

(21) Appl. No.: 18/254,427

(22) PCT Filed: Nov. 10, 2021
(86) PCT No.: PCT/EP2021/081247

§ 371 Date: May 25, 2023

(30) Foreign Application Priority Data
Nov. 25, 2020 (DE) 10 2020 214 812.0
Mar. 1, 2021 (EP) 21159855.2

(51) Int. Cl. C25B 15/021; C25B 1/04; C25B 9/67; C25B 15/027; C25B 15/08

(52) U.S. Cl. CPC C25B 15/021; C25B 1/04; C25B 9/67; C25B 15/027; C25B 15/08

(57) ABSTRACT

A process for operating an electrolysis apparatus for splitting water at both high and low ambient temperatures includes providing at least one electrolysis unit including at least one electrolytic cell and having at least one inlet opening for a first reactant stream and at least one outlet opening for a first product stream, producing the first product stream from the first reactant stream in the electrolysis unit, separating the product stream into water and gas streams, and cooling the water stream in at least one obliquely-oriented cooling apparatus dissipating the heat of the water stream directly to the environment. The cooling of the water stream is interrupted if the electrolysis unit is shutdown or the electrolysis unit is in standby operation. The ambient temperature is detected and, if the ambient temperature is below 1°, the water stream is emptied from the cooling apparatus into a liquid storage device.

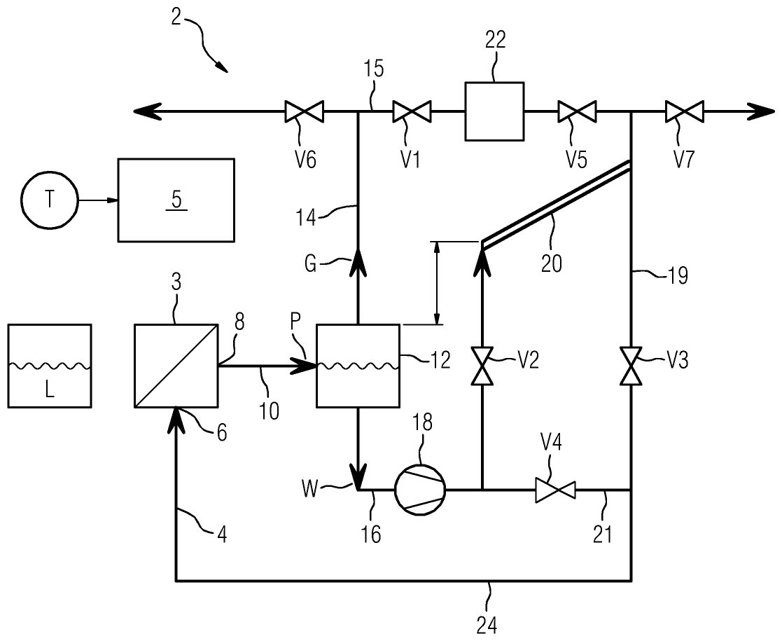

The invention relates to a process for operating an electrolysis apparatus and to such an electrolysis apparatus.

During the process of water splitting electrolysis generates heat as a consequence of electrical resistance losses. This heat must be dissipated to prevent overheating of the system. Heat removal is generally effected from the internal process water circuit, from which hydrogen gas and oxygen gas are obtained by water splitting process, using a heat exchanger on a further fluid circuit (for example a water-glycol mixture). This second fluid circuit transfers the heat flow to the surroundings (for example air, river water, underground).

The internal process water circuit is generally divided into two circuits: an O₂-side circuit and an H₂-side circuit, each having a heat exchanger. The heat flow in each of the circuits arises at a relatively low temperature level of between 40° C. and 70° C. In regions with high ambient temperatures (>30° C. or even >40° C.) the dissipation of the waste heat to the environment is a big problem. In such regions the situation can only be countered with large heat exchange areas. However, above a certain ambient temperature, in particular >40° C., it is in some cases no longer possible to maintain cooling performance.

In order to allow effective cooling of the electrolysis system in regions with a high ambient temperature the state-of-the-art approach is to provide a pre-cooled fluid via a very complex and costly compression cooling (“refrigerator effect”) and/or to spray water onto the cooler to generate an additional cooling effect via evaporative effects. The high capital costs/the resulting water losses mean that projects in these regions are difficult to make profitable. Furthermore, the considerable energy consumption of compression cooling contributes to a marked deterioration in efficiency, thus further reducing economy.

It is accordingly an object of the invention to provide an electrolysis apparatus where the cooling is cost effective and technically simple to realize, wherein the electrolysis apparatus is suitable for operation at both high and low ambient temperatures.

The present invention provides a process for operating an electrolysis apparatus for splitting water comprising the steps of:
providing at least one electrolysis unit comprising at least one electrolysis cell having at least one inlet opening for a first reactant stream and having at least one outlet opening for a first product stream,
producing the first product stream from the first reactant stream in the electrolysis unit,
separating the product stream into a water stream and a gas stream,
cooling the water stream by introducing it into at least one cooling apparatus in which the heat of the water stream is dissipated directly to the environment, wherein the cooling apparatus is arranged in an inclined orientation,
interrupting the cooling of the water stream in the case of a shutdown of the electrolysis unit or in standby operation of the electrolysis unit, and
detecting the ambient temperature during the offline state or the standby operation and if the ambient temperature is below 1° C. emptying the water stream from the cooling apparatus into a liquid storage means.

The object is further achieved according to the invention by an electrolysis apparatus for splitting water comprising:
an electrolysis unit comprising at least one electrolysis cell having at least one inlet opening for a first reactant stream and having at least one outlet opening for a first product stream,
at least one gas-water separator for separating the product stream into a water stream and a gas stream,
a cooling apparatus for cooling the water stream which is configured for direct dissipation of the heat of the water stream to the environment, wherein the cooling apparatus is arranged in an inclined orientation,
a control unit configured for interrupting the cooling of the water stream in the case of a shutdown of the electrolysis unit or in standby operation of the electrolysis unit, and
a temperature measuring apparatus for detecting the ambient temperature during the offline state or the standby operation, wherein the control unit is adapted for emptying the water stream (W) from the cooling apparatus into a liquid storage means if the ambient temperature is below 1° C.

According to the invention the electrolysis heat loss is cooled directly against the environment from the process water circuit and without a further heat transfer medium (air, river water, underground etc.). A further cooling fluid intermediate circuit is therefore dispensed with, i.e. the product-side water, also known as process water, is cooled directly against ambient air for example. Even at high external temperature a sufficiently large temperature difference between the process water (50-60° C.) and the external air (for example 40° C.) is present, thus ensuring efficient cooling. However, in order to allow such cooling apparatuses to be employed certain technical measures must be taken. Yet, direct cooling of the process water (without antifreeze, such as for example glycol) results in a risk of freezing in the cooling apparatus/in the conduits if the external temperatures fall below the freezing point of 0° C. The water stream to be cooled is ultrapure water and can therefore freeze, as a result of which the cooling system may be damaged by volume expansion. The process water to be cooled in the cooler apparatus must also be protected from frost during plant shutdowns. The cooling apparatus is in particular protected from environmental influences, for example via a blind, a frostproof housing (such as a building), via heating, via integration of a heat storage means etc. When the electrolysis apparatus is in the shutdown state and no cooling is required but the ambient temperature is near 0° C. or below, the cooling apparatus is emptied and intermediately stored. The pure water from the cooling apparatus is intermediately stored in a liquid storage means (internal or insulated/heated in the case of external deployment) for the duration of the offline state of the electrolysis unit.

In a preferred variant the cooling apparatus is emptied via a height difference between the cooling apparatus and the liquid storage means. To this end the cooling apparatus is arranged in an inclined orientation for example in order thus to simplify the emptying operation. This means that an outflow side of the cooling apparatus through which the water is emptied is lower than the opposite inflow side. The outflow side especially forms the lowest point of the cooling apparatus.

The water in the emptied cooling apparatus is advantageously replaced by a gas. The gas is required to avoid negative pressure/to maintain a defined positive pressure in the system and the gas may be a process gas or, for example, an inert gas.

In a further preferred variant, as an alternative or additionally to the emptying via the height difference, the cooling apparatus is emptied by pressurizing with pressurized gas which is typically a process gas. This may make use in particular of the product gas already present in the electrolysis apparatus which is generally stored in a gas storage means. The anode side especially employs compressed air to displace the process water for the cooling circuit.

Having regard to an embodiment of particularly simple construction the liquid storage means employed is preferably the gas-water separator.

Alternatively or in addition to the use of the gas-water separator is a liquid storage means, especially when the volume of the gas water separator is insufficient, the liquid storage means employed is preferably an additional container which is arranged for example between the gas water separator and the cooling apparatus.

Working examples of the invention are more particularly elucidated with reference to a drawing. The sole FIGURE shows an electrolysis apparatus 2 (PEM or alkaline electrolysis apparatus) having an electrolysis unit 3 comprising at least one electrolysis cell (not shown) for splitting water. The electrolysis apparatus 2 additionally comprises a control unit 5 which is shown symbolically in the FIGURE. The control unit 5 controls the individual components of the electrolysis apparatus 2 as a function of the wide variety of stored, calculated or detected parameters.

The electrolysis unit 3 has a first reactant stream 4 introduced into it via an inlet opening 6. The electrolysis unit 3 further comprises at least one first outlet opening 8 for a product stream P which is produced from the reactant stream 4 in the electrolysis unit 3 and discharged from the electrolysis unit 3 via a product conduit 10 which is connected to the outlet 8. The construction of the electrolysis apparatus 2 described below may be provided both on the cathode side and on the anode side. The construction shown in the FIGURE is especially present on both the cathode side and the anode side though only one side is shown.

The product stream P is a fluid mixture consisting of a liquid, in this case water, and the gas (hydrogen on the cathode side, oxygen on the anode side). After discharging the product stream P from the electrolysis unit 3 said stream is divided in a gas water separator 12 into a gas stream G and a water stream W. The gas-water separator 12 may be operated under pressure, though a pressureless configuration is also possible where the separation of the gas from the liquid (water) is effected by gravity.

The gas stream G is sent on via a gas conduit 14, with valve V6 installed in the gas conduit 14 being in the open state, to a gas takeoff (not shown) and exits the electrolysis apparatus 2. To this end valve V1, which is integrated in a branch 15 from the gas conduit 14, remains closed. In the open state of the valve V1 the gas is passed into a gas storage means 22, into which conduit 15 opens.

The water stream W separated from the gas stream G is conveyed via a water conduit 16 using a circulation pump 18 via an open valve V2 into a cooling apparatus 20 (heat exchanger) and there dissipates its heat directly to the environment.

Via a recirculation conduit 19 at an open valve V3 the water stream W proceeds from the cooling apparatus 20 back to the electrolysis unit 3 in order, in its cooled state, to take part in the electrolysis process again.

To accommodate fluid issuing from the cooling apparatus 20 a low pressure or pressureless reservoir vessel may be employed instead of the pressure resistant gas-water separator 12, wherein a water pump conveys the intermediately stored water W into the cooling circuit.

Using the bypass conduit 24 with the valve V4 the cooling apparatus 20 may be partially to completely bypassed. The bypass conduit 24 serves to control the fluid temperature at the inlet to the electrolysis unit 3. The position of the valve V4 shown in the FIGURE represents only one of many possible embodiments: it may be arranged for example upstream of the valve V2, downstream of the valve V3, downstream of the valve V2 or between the valves V2 and V3. V4 is controllable according to the temperature of the process water but also serves for startup and preheating of the electrolysis apparatus 2. Temperature-dependent control of the valves V2 and V3 is also conceivable.

In the case of shutdown of the electrolysis unit 3 or in standby operation at a very low output of the electrolysis unit 3 a cooling of the process water W is no longer necessary. The cooling thereof in the cooling apparatus 20 is therefore interrupted. Simultaneously a temperature measuring apparatus (not shown) is used to detect ambient temperature. However, when the ambient temperature is close to or below freezing point, i.e. below 1° C., the process water W can freeze and thus damage the electrolysis apparatus 2. This is why the ambient temperature is detected and if this is close to freezing point, in particular below 1° C., the control unit (5) ensures that the cooling apparatus 20 and optionally parts of the feed and discharge conduits are dewatered.

One option therefor is a forced “dewatering” with compressed gas, in which the gas from the gas storage means 22 is used for this purpose. In a first step the valve V1 is opened and compressed gas from the product-side gas stream 14 passes into the gas storage means 22. At this point a valve V5 arranged downstream of the gas storage means 22 is closed. After charging the gas storage means 22 (pressure dependent and/or time-dependent control) the valve V1 is closed. Gas production is stopped at this time and cooling is no longer necessary. A partial or even complete decompression of the electrolysis apparatus 2 is effected via the valve V6. In addition the gas from the gas storage means 22 displaces the water W from the cooling apparatus 20 which passes via the electrolysis unit 3 into the gas-water separator 12 and is initially stored therein. Alternatively or in addition, when the volume of the gas-water separator 12 is too low, an additional container for liquid accommodation may be used. This could be configured for a low pressure. Small free volumes in the gas-water separator 12 can lead to a pressure increase as a result of the inflowing liquid. In this case the valve V6 is opened as a function of pressure to maintain the pressure in the gas-water separator 12.

A further option is gravitational dewatering. The driving force in the embodiment shown in the FIGURE is the height difference between the cooling apparatus 20 and the liquid storage means, in this case the gas-water separator 12. The emptying is effected analogously to the forced “dewatering” i.e. via the valve V5 gas is introduced into the system merely to avoid a negative pressure/to maintain a defined positive pressure in the system. The “inclined orientation” of the cooling apparatus 20 to bring about a defined outflow and inflow direction is advantageous in both embodiments.

For both working examples described below the restarting at very low temperatures may be critical since excessively low temperatures can cause the cooling apparatus 22 to block due to icing in the cooling channels.

In a first embodiment the electrolysis process is used as a gas generator to increase the pressure in the gas-water separator 12 and in the gas storage means 22. Valves V2, V3, V5, V6 and V7 are closed while valves V1 and V4 are open. The process water W circulates in the bypass conduit 24 and is preheated. In the gas-water separator 12 and in the gas storage means 22 gas pressure is built up. Upon reaching a predefined minimum pressure, valve V2 opens and the closed valve V7 ensures maintenance of a defined pressure. The cooling apparatus 20 is filled. V7 is a pressure maintenance valve which is opened for a pressure relief but terminates depressurization at a pressure higher than ambient pressure, for example 1.5 bar.

Alternatively or in addition an external pressure source may be provided. An external compressed gas storage means (not shown) is used to pressurize the system by opening valve V6 and optionally valve V2. If a gas volume were included in the cooling apparatus, a sudden pressure equalization would not be able to occur after the pressurization and the opening of V2. The system is pre-pressurized and may be filled analogously to the above-described autogenous pressure generation.

The gas storage means 22 may be dispensed with if an external high pressure gas supply is available.

On the anode side of the electrolysis apparatus 2 air may be used directly for displacement. Alternatively both on the cathode side and on the anode side nitrogen from a nitrogen system may be used for displacement.

The valve V7 may be necessary for deaerating if the gas bubbles entrained to a small extent are not discharged by the flow out of the cooling apparatus 20. Or optionally a substream or whole-stream ion exchanger is arranged in the circulation system.

1-7. (canceled)

8. A process for operating an electrolysis apparatus for splitting water, the process comprising steps of:
providing at least one electrolysis unit including at least one electrolysis cell, the at least one electrolysis unit having at least one inlet opening for a first reactant stream and at least one outlet opening for a first product stream;
producing the first product stream from the first reactant stream in the electrolysis unit;
separating the product stream into a water stream and a gas stream;
cooling the water stream by introducing the water stream into at least one cooling apparatus dissipating heat of the water stream directly to the environment, the cooling apparatus having an inclined orientation;
interrupting the cooling of the water stream upon a shutdown of the electrolysis unit or during a standby operation of the electrolysis unit; and
detecting an ambient temperature during an offline state or the standby operation and upon the ambient temperature being below 1° C., emptying the water stream from the cooling apparatus into a liquid storage device.

9. The process according to claim 8, which further comprises emptying the cooling apparatus by a height difference between the cooling apparatus and the liquid storage device.

10. The process according to claim 9, which further comprises replacing the water in the emptied cooling apparatus by a gas.

11. The process according to claim 9, which further comprises emptying the cooling apparatus by pressurizing with pressurized gas.

12. The process according to claim 11, which further comprises using a process gas as the pressurized gas.

13. The process according to claim 9, which further comprises providing a gas-water separator as the liquid storage device, and using the gas-water separator to effect the separation of the water stream and the gas stream during operation.

14. The process according to claim 9, which further comprises using an additional container as the liquid storage device.

15. An electrolysis apparatus for splitting water, the electrolysis apparatus comprising:
an electrolysis unit including at least one electrolysis cell, at least one inlet opening for a first reactant stream and at least one outlet opening for a first product stream;
at least one gas-water separator for separating the product stream into a water stream and a gas stream;
a cooling apparatus for cooling the water stream, said cooling apparatus being configured for direct dissipation of heat of the water stream to the environment, and said cooling apparatus being disposed in an inclined orientation;
a control unit configured for interrupting the cooling of the water stream upon a shutdown of said electrolysis unit or during a standby operation of said electrolysis unit; and
a temperature measuring apparatus for detecting an ambient temperature during an offline state or the standby operation;
said control unit configured for emptying the water stream from said cooling apparatus into liquid storage upon the ambient temperature being below 1° C.
